(19) United States
(12) Patent Application Publication
(10) Pub. No.: US 2006/0281469 A1
(43) Pub. Date: Dec. 14, 2006

(54) Employee tracking system with verification

(76) Inventors: Gary Stoller, Roslyn Heights, NY (US); Stephen Silverstein, Sands Point, NY (US)

Correspondence Address: George H. Gerstman;Seyfarth Shaw LLP, Suite 4200, 55 East Monroe Street, Chicago, IL, 60603, US

(21) Appl. No.: 11/152,279

(22) Filed: Jun. 14, 2005

(51) Int. Cl. H04Q 7/20

(52) U.S. Cl. 455/456.1

(57) ABSTRACT

A method and system for verifying that an employee and a client are present at a single location. A telephonic communications channel is established between the single location and a location verification system provider. Data is received at the system provider, from the employee over the telephonic communication channel. Data is received, at the system provider, from the client over the telephonic communication channel. The client data is separate from the employee data. The identity of the employee and the client are verified through a comparison of the employee data and the client data to preexisting data located in a database. A determination is made whether or not the employee and the client are present at the single location in response to the step of identifying.

### FIELD OF THE INVENTION

The present application concerns a novel employee tracking system, and, more particularly, a novel computer-based system for collecting data to verify the presence of people at a single location during a telephone call.

### BACKGROUND OF THE INVENTION

Systems are known for tracking persons, such as employees, by using computer-based telephone tracking and reporting systems. For this purpose, a computer-based tracking and reporting service may have a number of customers, each of which is a company with employees that provide services to a client. For example, the customer may be a nurses association, the employees of which are nurses who provide nursing services to a patient at the patient's home. In the parlance of the computer-based tracking service, the nurses association is the customer, the nurse is the “employee” or “caller”, and the person receiving the service from the employee-caller is the “client.” Tracking services are also useful for non-commercial applications. For instance, it can be used by prison systems to determine if a parolee has met with a parole officer.

Ordinarily the employee-caller is scheduled to provide services at the client's address at a specified date for a specified amount of time. The nurses association (i.e., the customer) may want to track the nurse's time of arrival, time of departure, etc. at the client's location in order to have a record of the nurse's activity and amount to be paid to the nurse for the nursing services and/or to the nurses association by a medical insurance company.

In one prior system, the employee calls a telephone number when the employee arrives at the client's location. When the call is received, the Dialed Number Identification Service (DNIS) is detected and the Automatic Number Identification (ANI) is also detected. The DNIS is compared with a customer database and the employee is requested to enter the appropriate data. The entered data, the DNIS, the ANI, and other information such as the time and date of the call is recorded and saved. However, on occasion the employee, caller, may enter the wrong caller identification, and the system will record an incorrect caller identification code and will be unable to determine the correct identification of the caller.

In another system, a computer-based system is provided for collecting data from callers, including a customer's database corresponding to a customer's Dialed Number Identification Service (DNIS) and in which system the caller has an identification code. When a call is received, the DNIS is detected and is compared with the customer's database to determine the data to collect during the call. If a caller identification code is required, then the caller identification code is obtained and the caller identification code is compared, via the computer, with a check digit algorithm without referencing a caller identification code database. After the call is terminated, a call record is created for the received call.

Now that cellular, or mobile phones are in wide use, however, it is difficult to determine the location of the employee through utilization of the previous methods. Accordingly, what is needed is a method and system, which can verify, regardless of the technology used, that the employee is at the proper location, i.e. with the patient. To this end, applicant has discovered a system for verification of two or more people during a single phone call.

Other objects and advantages of the present invention will become apparent as the description proceeds. It is to be understood, however, that although the terms “telephone” or “telephonic” are used for convenience herein to refer to the medium upon which communication is achieved, these terms are intended to include cable transmission, satellite transmission, and any other type of transmission upon which communication can be achieved.

### SUMMARY

In one example, a method for verifying that an employee and a client are present at a single location is provided. A telephonic communications channel is established between the single location and a location verification system provider. Data is received, at the system provider, from the employee over the telephonic communication channel. Data is received, at the system provider, from the client over the telephonic communication channel. The client data is separate from the employee data. The identities of the employee and the client are verified through a comparison of the employee data and the client data to preexisting data located in a database. Finally, it is determined whether or not the employee and the client are present at the single location in response to the step of identifying the employee and client.

In another example, an article for verifying that an employee and a client are present at a single location is provided. The article includes a computer-readable signal-bearing medium. There is logic in the medium that includes hardware logic, software logic, logic embedded in a communications signal, or some combination thereof that perform various activities. There is logic to establish a telephonic communication channel between the single location and a location verification system provider. There is logic in the medium for receiving data, at the system provider, from the employee over the telephonic communication channel. There is logic in the medium for receiving data, at the system provider, from the client over the telephonic communication channel, wherein the client data is separate from the employee data. There is logic in the medium for verifying the identity of the employee and the client through a comparison of the employee data and client data to preexisting data located in a database. Finally, there is logic in the medium for determining whether or not the employee and the client are present at the single location in response to an indication from the logic in the medium for verifying.

In a further example, a method for verifying that an employee and a client are present at a single location is provided. A telephonic communication channel is established between the single location and a location verification system provider. The employee sends data over the communication channel that includes information that can be used by the location verification system provider to identify the employee. The client sends data over the communication channel that includes information, which is different from the information sent by the employee, that can be used by the location verification system provider to identify the client.

### BRIEF DESCRIPTION OF THE DRAWINGS

FIG. 1 is a block diagram depicting one example of a system for verifying that an employee and client are present at a single location.

FIG. 2 is a functional block diagram depicting exemplary operation of the system of FIG. 1.

FIG. 3 is a functional block diagram depicting an exemplary verification method that can be used in the operation shown in FIG. 2.

### DETAILED DESCRIPTION

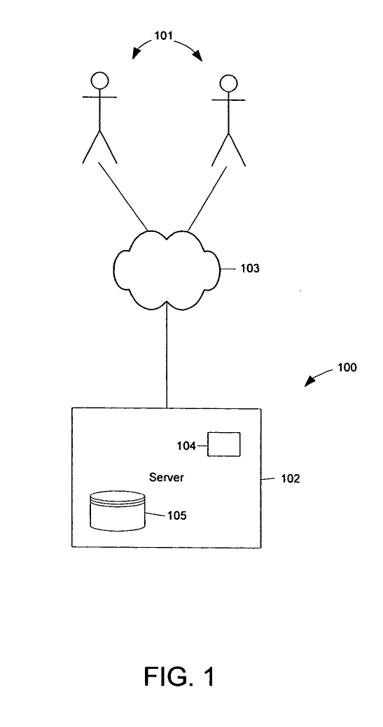

Referring to FIG. 1, an example of a location verification system 100 for verifying that at least two people 101, such as an employee and a client, are present at a single location is provided for illustrative purposes. The system 100 in one example includes a server 102. The server 102 can be connected to at least two people 101 through a network 103.

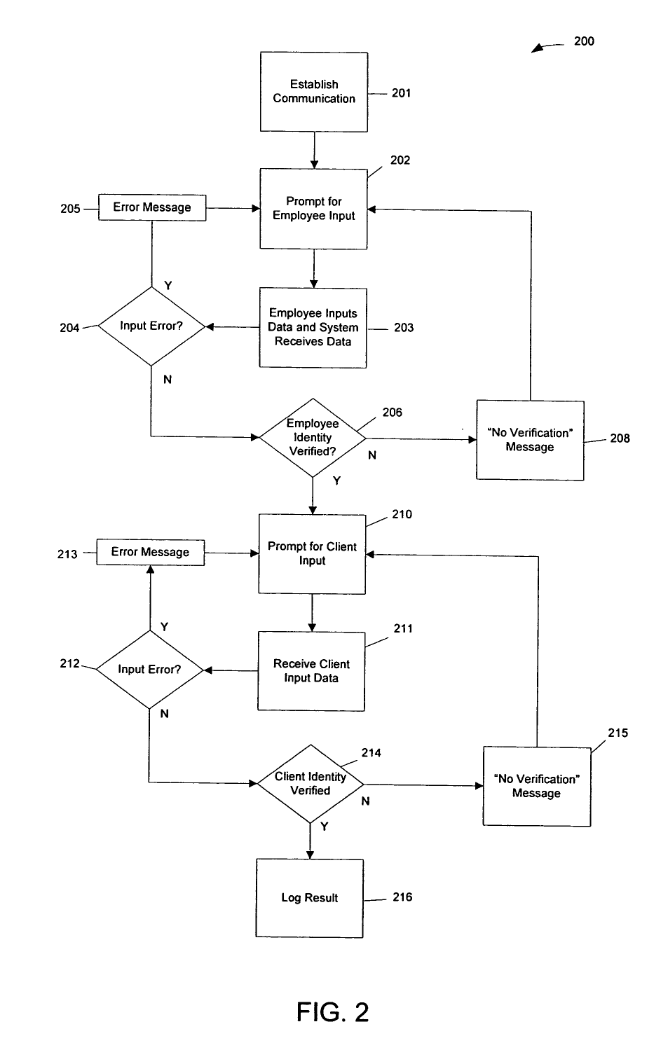

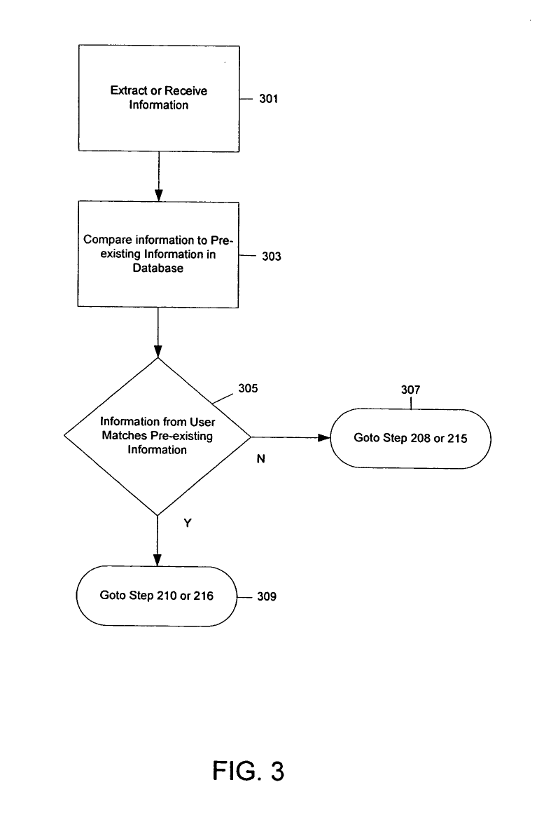

FIGS. 2-3 depict a process 200 by which system 100 is utilized to verify that at least two people 101 are present in a single location. The process 200 in one example is performed on server 102. In another example, process 200 can be performed on another type of computing device or system. For example, the computing device could be a personal computer, a workstation, a file server, a mainframe, a personal digital assistant (“PDA”), a mobile telephone, or a combination of these devices. In the case of more than one computing device, the multiple computing devices could be coupled together through the network 103.

The network 103 in one example includes any network that allows multiple computing devices to communicate with one another (e.g., a Local Area Network (“LAN”), a Wide Area Network (“WAN”), a wireless LAN, a wireless WAN, the Internet, a wireless telephone network, etc.) In a further example, the network 103 comprises a combination of the above mentioned networks. The computing device can be connected to the network through landline (e.g., T1, DSL, Cable, POTS) or wireless technology, such as that found on mobile telephones and PDA devices.

Referring to FIG. 1, the server 102, or whatever computing device is utilized, includes one or more logic components 104 such as computer software and/or hardware components to carry out the process 200. A number of such components can be combined or divided. An exemplary component employs and/or comprises a series of computer instructions written in or implemented with any of a number of programming languages, as will be appreciated by those skilled in the art.

In one example, the process 200 is embedded in an article including at least one computer-readable signal-bearing medium. One example of a computer-readable signal-bearing medium is a recordable data storage medium such as a magnetic, optical, and/or atomic scale data storage medium. In another example, a computer-readable signal-bearing medium is a modulated carrier signal transmitted over a network comprising or coupled with computing device or system, for instance, a telephone network, a local area network (“LAN”), the Internet, and/or a wireless network.

Referring further to FIG. 1, server 102 is programmed and configured such that it can establish communication with at least two people 101 over network 103. For convenience, this disclosure will refer to network 103 as a voice communication network by which at least two people 101 connect to server 102, which for convenience will be referred to as a call server.

Call server 102 has numerous trunk lines dedicated to a number of customers, and different customers have different requirements with respect to the data that is expected to be received. For example, one customer may have employees who speak Spanish or who deal with clients that speak Spanish. Each employee or client may have a numerical employee identification code that must be entered into the system via the telephone keypad for the employee or client to be identified. On the other hand, another customer may require that the message be in English and also use a numerical employee or client identification code. Alternatively, another customer may also require English, but may require a voice print or some form of biometric data from the employee or client as the means of identification. Still further, another customer may require an English message and also require that the caller's identification code be spoken in English, rather than entered on the telephone key pad. It can thus be seen that there are numerous combinations of languages and caller identification codes that can be used in the collection of data.

Call server 102 in one example includes a database 105. Database 105 includes preexisting information regarding the at least two people 101 that allow system 100 to verify the identity of the at least two people 101. For instance, if the customer prefers that the client and employee verify their identity with numerical data from a telephone key pad, the database will include the numerical identifiers and codes that correspond to each client and employee. Similarly, if the customer prefers the use of voice verification technology, the database 105 will contain preexisting voice prints for each client and employee. If the customer prefers the use of biometric data, then the database 105 will contain data representative of a biometric characteristic, such as fingerprint or eye scan data, for each employee or customer.

Referring to FIG. 2, the process 200 starts in step 201 in which communication is established between the at least two people 101 and system 100. As was discussed previously, communication could be established by the one of the at least two people 101 dialing into system 100 over a telephone network 103. After establishment of communication, the system 100, in step 202, will prompt one of the at least two people 101 for input. In FIG. 2, it is shown for illustrative purposes that the system 100 prompts the employee for input. In another example, the system 100 could first prompt the client for input. Further, the at least two people 101 do not necessarily need to have an employee/client relationship. It is envisioned that the system 100 could be used for other applications. For instance, the at least two people 101 could be a parole office and a parolee The system 100 will work for applications in which it is necessary to verify that two people are together.

Referring still to FIG. 2, the particular prompt that the employee receives in step 202 can take many forms, e.g. a recorded voice message, an audible series of tones, a computer generated message, etc. After receiving the prompt, in step 203, the user, in this case the employee, will input data and the system will receive data. The data will include some means of identifying the employee. For example, the employee might enter an employee code by using a telephone touch pad, or the employee might swipe a RFID card in a card reader that will send data to system 100. In another example, the employee might simply state his or her name, and the system will, by using voice recognition technology, extract information from the audio signal that will identify the employee. In step 204, the system 100 will determine if the user entered the data correctly. If for some reason, the employee did not enter the data correctly, then an error condition will occur, and the system 100 will provide an error message to the employee in step 205. The process then returns to step 202 and prompts the employee for input. If after a predetermined number of attempts, the employee still does not enter correct data, the system 100 could perform an action, such as hanging up or transferring the employee to an operator or help menu.

In step 206, system 100 verifies the employee's identity. Referring to FIG. 3, an exemplary description of how verification occurs will be provided for illustrative purposes. In step 301, the system 100 receives or extracts information from the data sent by the user. The system 100, in one example, performs step 301 by digitally processing the key strokes or biometric data sent from the user or by taking a voice print. In step 303, the system 100 compares the information to pre-existing information stored in the database 105. For example, in the case of a voice print, the system 100 will compare the voice print of the employee to pre-existing voice prints. In the case of an touch tone code, the system will compare the code received from the employee to pre-existing codes in the database. In step 305, the system 100 determines whether there is a match. If there is a match, then flow proceeds to step 210 in FIG. 2 and the system 100 prompts the client for input. If no match occurs, then flow proceeds to step 208 in FIG. 2 and the system 100 will provide an indication to the user that there was no match. The user can then reenter the identification data in step 202. As with entering incorrect data, if the user fails to correctly verify his or her identity after a predetermined number of attempts, the system 100 could hang up or transfer the user to a help menu or operator. Alternatively, step 208 could be omitted and flow could simply proceed to step 210.

In steps 210 through 215, the preceding steps are repeated for the second user, in this instance, the client. If the system 100 is in use for more than two people, the steps will repeat for the additional users, until all of the users have attempted a verification. When the steps of receiving data and verifying identities is complete, then in step 216, the system will log the result, either in the database 105 or some other computer-readable signal-bearing medium, in step 216. The result can include information, such as the time of the communication, identities of the callers, the DNIS, the ANI, and the result of the verification step. The customer will then have access to the result for each call. In this way, the customer will be able to determine whether the employee and client were together at a particular time.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

1. A method for verifying that an employee and a client are present at a single location, the method comprising:
establishing a telephonic communications channel between the single location and a location verification system provider,
receiving data, at the system provider, from the employee over the telephonic communication channel,
receiving data, at the system provider, from the client over the telephonic communication channel, wherein the client data is separate from the employee data,
verifying the identity of the employee and the client through a comparison of the employee data and the client data to preexisting data located in a database, and
determining whether or not the employee and the client are present at the single location in response to the step of identifying.

2. The method of claim 1, wherein the step of establishing comprises establishing a mobile telephonic communications channel.

3. The method of claim 1, wherein the step of establishing comprises establishing a telephonic communications channel over a plain old telephone service (POTS) line.

4. The method of claim 1, wherein the employee data and the client data each have a format selected from the group consisting of voice data, biometric data, touchtone data, and radio frequency identification card data.

5. The method of claim 4, wherein the employee data and the client data are sent in different formats.

6. The method of claim 1, further comprising:
extracting employee information from the employee data through utilization of a voice recognition algorithm, and
extracting client information from the client data through utilization of the voice recognition algorithm.

7. The method of claim 6, further comprising:
comparing the employee information to preexisting employee information in the database, and
comparing the client information to preexisting client information in the database.

8. The method of claim 7, wherein the step of determining comprises determining that the client and the employee are at the single location if the employee information matches the preexisting employee information and the client information matches the preexisting client information.

9. The method of claim 8, further comprising:
storing an indication in a memory that the employee and the client are at the single location.

10. An article for verifying that an employee and a client are present at a single location, comprising:
a computer-readable signal-bearing medium;
logic in the medium for establishing a telephonic communication channel between the single location and a location verification system provider;
logic in the medium for receiving data, at the system provider, from the employee over the telephonic communication channel,
logic in the medium for receiving data, at the system provider, from the client over the telephonic communication channel, wherein the client data is separate from the employee data,
logic in the medium for verifying the identity of the employee and the client through a comparison of the employee data and client data to preexisting data located in a database; and
logic in the medium for determining whether or not the employee and the client are present at the single location in response to an indication from the logic in the medium for verifying.

11. The article of claim 10, wherein the logic in the medium for establishing comprises logic in the medium for establishing a mobile telephonic communications channel.

12. The article of claim 10, wherein the logic in the medium for establishing comprises logic in the medium for establishing a telephonic communications channel over a plain old telephone service (POTS) line.

13. The article of claim 10, wherein the employee data and the client data each have a format selected from the group consisting of voice data, biometric data, touchtone data, and radio frequency identification card data.

14. The article of claim 13, wherein the employee data and the client data are sent in different formats.

15. The article of claim 10, further comprising:
logic in the medium for extracting employee information from the employee data through utilization of a voice recognition algorithm, and
logic in the medium for extracting client information from the client data through utilization of the voice recognition algorithm.

16. The article of claim 15, further comprising:
logic in the medium for comparing the employee information to preexisting employee information in the database, and
logic in the medium for comparing the client information to preexisting client information in the database.

17. The article of claim 16, wherein the logic in the medium for determining comprises logic in the medium for determining that the client and the employee are at the single location if the employee information matches the preexisting employee information and the client information matches the preexisting client information.

18. The article of claim 17, further comprising:
logic in the medium for storing an indication in a memory that the employee and the client are at the single location.

19. A method for verifying that an employee and a client are present at a single location, comprising:
establishing a telephonic communication channel between the single location and a location verification system provider,
the employee sending data over the communication channel that includes information that can be used by the location verification system provider to identify the employee,
the client sending data over the communication channel that includes information, which is different from the information sent by the employee, that can be used by the location verification system provider to identify the client.

20. The method of claim 19, wherein the employee data and the client data each have a format selected from the group consisting of voice data, biometric data, touchtone data, and radio frequency identification card data.

21. A method for verifying that at least two people are present at a single location, the method comprising:
establishing a telephonic communications channel between the single location and a location verification system provider,
receiving data, at the system provider, from a first person over the telephonic communication channel,
receiving data, at the system provider, from a second person over the telephonic communication channel, wherein the first person data is separate from the second person data,
verifying the identity of the first person and the second person through a comparison of the first person data and the second person data to preexisting data located in a database, and
determining whether or not the first person and the second person are present at the single location in response to the step of identifying.
